(19) United States
(12) Patent Application Publication
(10) Pub. No.: US 2021/0404512 A1
(43) Pub. Date: Dec. 30, 2021

(54) Crankshaft

(71) Applicant: Bayerische Motoren Werke Aktiengesellschaft, Muenchen (DE)

(72) Inventors: Stefan KAMMERSTAETTER, Scharnstein (AT); Stefan REICHL, Ried in der Riedmark (AT)

(21) Appl. No.: 17/281,488

(22) PCT Filed: Sep. 5, 2019
(86) PCT No.: PCT/EP2019/073659

§ 371 Date: Mar. 30, 2021

(30) Foreign Application Priority Data
Oct. 16, 2018 (DE) 10 2018 125 617.5

(51) Int. Cl. F16C 3/08

(52) U.S. Cl. CPC F16C 3/08; F16C 2240/54; F16C 2220/44; F16C 2204/62; F16C 2360/22; F16C 2204/70; F16C 2220/70; F16C 2223/06; F16C 2204/64

(57) ABSTRACT

The invention relates to a crankshaft (1) for a reciprocating piston internal combustion engine having at least two main bearings (2) a crank pin (3). Crankshaft flanges (4) are arranged between each of the main bearings and the crank pin and connect the main bearings to the crank pin. The crankshaft has at least one ring gear (5) spaced apart axially from a main bearing for a drive of a chain drive. A crankshaft surface between the main bearing and the first ring gear has an averaged roughness depth R z of less than 3 micrometres. Due to the configuration of the crankshaft according to the invention for a reciprocating piston internal combustion engine, higher torsional moments can be transmitted or the crankshaft can be designed to be lighter in the area having the higher surface quality.

### BACKGROUND AND SUMMARY OF THE INVENTION

The disclosure relates to a crankshaft for a reciprocating-piston internal combustion engine.

With regard to the technical field, reference is made for example to an existing method for increasing the fatigue strength of crankshafts for piston machines, in particular internal combustion engines, in the case of which crankshafts the transition radii between a crankpin and adjoining crank webs are subjected to a particular treatment. Said treatment consists of a hardening in the region of the transition radii to a hardening depth of 2-3 mm, along with a machining of the surface, proceeding from an intersection edge between a bearing point and a transition radius as far as the end of the run-on collar, to a roughness depth R_{z} greater than 6.3 μm.

Furthermore, in an existing crankshaft that is provided in particular for air-compressing supercharged injection-type engines, the crankshaft comprises main bearing journals and connecting-rod bearing journals. The main bearing journals are loaded to a lesser extent than the connecting-rod bearing journals, wherein, prior to operation of the crankshaft, the main bearing journals have a greater roughness depth than the connecting-rod bearing journals.

Additionally, an existing bearing apparatus for internal combustion engines comprises a crankshaft of an internal combustion engine, wherein the crankshaft is held by bearings, and the crankshaft is produced from steel which has not undergone any surface hardening and which has a structure composed primarily of perlite and of a proportion of proeutectoid ferrite of at most 3%. The steel is also machined in order to have a roughness depth R_{z} of at most 0.8 μm, wherein the bearings comprise an aluminum bearing alloy which is connected to a base plate and, as an alloy constituent of said alloy, comprise less than 4 weight percent of silicon particles. In this way, prevention of premature wear and of scratching of the crankshaft occurs in such a way that it is equivalent or advantageous in comparison with the wear and the scratching in the case of conventional DCI shafts.

A crankshaft, which is used for the BMW in-line six-cylinder diesel engine with the internal designation B57, is also depicted by way of example in FIG. 1. The maximum transmittable torsional moment (including any alternating torsional moments) represents a crucial design criterion for the crankshaft in the internal combustion engine. Previous investigations have shown this to be critical in the region between the cylindrical part of the crankshaft and the transition to the sprockets which are machined at the same time as the crankshaft. In the current prior art, said region is configured in the form of a transition radius by means of turning machining.

The turning machining in said region generates a surface quality in the range of approximately R_{z}=7 μm. Results on a torsional pulse test stand show a limitation of the maximum possible torsional fatigue strength on account of possible incipient cracks in the critical region of the transition radii, inter alia as a result of comparatively high surface roughness.

It is an object of the present disclosure to increase the maximum transmittable torsional moment for a crankshaft of the generic type.

Said object and other object are achieved by the a crankshaft for a reciprocating-piston internal combustion engine of this application.

The use of different manufacturing processes makes it possible to increase the surface quality in the critical regions to a mean of the roughness depths R_{z} of less than 3 μm. Possible processes considered may in this case be, inter alia, grinding, finishing or else polishing (in the form of pure surface smoothing). All of the processes are associated with a significant smoothing of the surface in the critical region.

Investigations on a torsional pulse test stand have shown that the increase in the surface quality in critical regions, in particular in the region of the transition radii to the sprocket, from approximately R_{z}=7 μm to R_{z} less than 3 μm makes it possible to achieve a demonstrable increase in the torsional fatigue strength of the entire crankshaft in the range of 10 to 30%. By way of rolling in the form of deep rolling (increasing the internal compressive stress), a significantly higher increase in strength is again to be expected. Firstly, there is thus the possibility of transmitting higher torsional moments by way of the crankshaft. Secondly, in the context of a lightweight construction approach with an identical torque to be transmitted, the crankshaft can be constructed in a more lightweight manner and thus with less starting material.

With the configuration according to the crankshaft for a reciprocating-piston internal combustion engine of this application, the torsional fatigue strength can be further improved.

The manufacturing processes disclosed in this application are particularly preferred manufacturing processes.

The materials disclosed in this application are particularly preferred crankshaft materials.

With the configuration disclosed in this application, the formation of cracks is again significantly counteracted.

Other objects, advantages and novel features of the present disclosure will become apparent from the following detailed description of one or more preferred embodiments when considered in conjunction with the accompanying drawings, in which:

### BRIEF DESCRIPTION OF THE DRAWINGS

FIG. 1 shows a view of a crankshaft according to the prior art; and

FIG. 2 shows a section through an end piece of a crankshaft with the inventive machining.

### DETAILED DESCRIPTION OF THE DRAWINGS

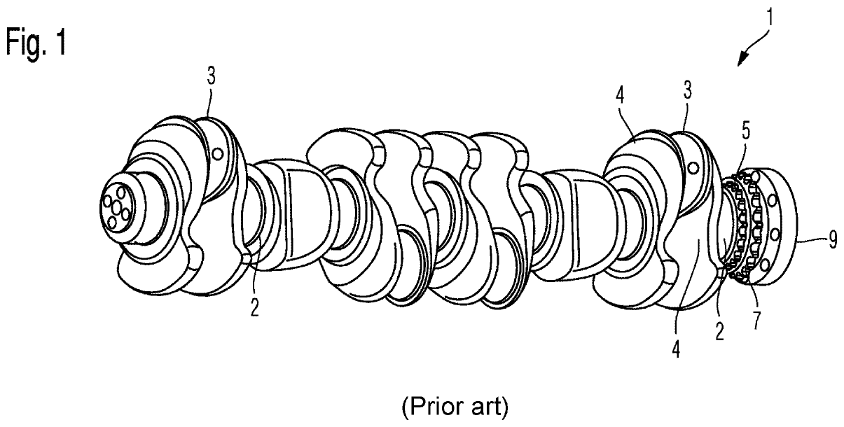

FIG. 1 shows a view of a crankshaft 1 according to the prior art. By way of example, the crankshaft 1 illustrated in FIG. 1 is a stock crankshaft for the 6-cylinder BMW in-line engine with the internal designation B57.

The crankshaft 1 comprises seven main bearings 2 and six crankpins 3, wherein the main bearings 2 and the crankpins 3 are connected via crank webs 4. The crank webs 4 can be configured with or without counterweights. A flange 9 is located at an end of the crankshaft 1. Located between the flange 9 and the adjacently arranged main bearing 2 in the present exemplary embodiment are two toothed rings 5, 7, which are manufactured together with the crankshaft 1, for chain drives (not illustrated).

In the series version, a crankshaft surface between the flange 9 and the main bearing 2 has a mean roughness depth of about 7 um. Results on a torsional pulse test stand have shown that there is a limitation of the maximum possible torsional fatigue strength for this known crankshaft 1, since incipient cracks, which may lead to damage of the crankshaft 1, can occur in the region of the first toothed ring 5 and of the second toothed ring 7.

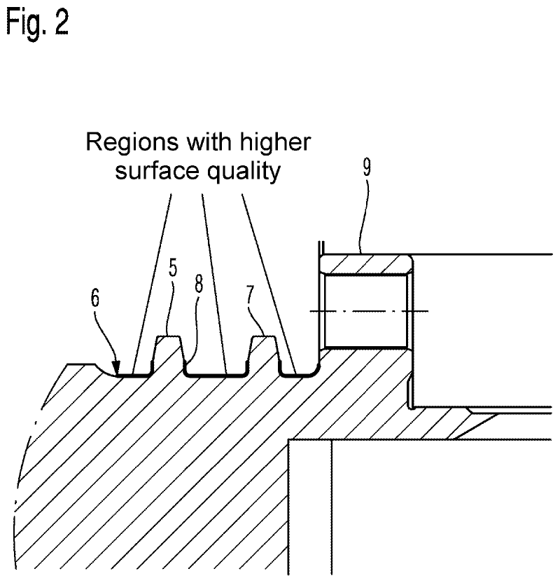

FIG. 2 shows a section through a flange-side end of a crankshaft 1 according to the invention in the region of the flange 9 and of the first toothed ring 5 and of the second toothed ring 7. According to the invention, the crankshaft surface 6 between the main bearing 2 and the first toothed ring 5 has a mean roughness depth R_{z} of less than 3 μm. The crankshaft surface 6 between the first toothed ring 5 and the second toothed ring 7 also has a mean roughness depth R_{z} of less than 3 μm. Furthermore, the crankshaft surface 6 which is located adjacent to the second toothed ring 7, on the side opposite the first toothed ring 5, also has a mean roughness depth R_{z} of less than 3 μm.

In a particularly preferred embodiment, the crankshaft surface 6 with the mean roughness depth R_{z} of less than 3 μm extends up to the toothed ring flanks 8.

The mean roughness depth R_{z} of less than 3 μm is preferably produced by grinding or finishing or polishing. In addition, the crankshaft 1 is preferably formed of a steel material, such as, for example, C38+N or C38MOD or 44MNSIVS6 or 37CRS4MOD or 42CRMO4.

In principle, the crankshaft according to the invention can be forged or cast.

Investigations on a torsional pulse test stand have shown that the increase according to the invention in the surface quality in the abovementioned critical regions, in particular in the region of the transition radii to the sprocket, from approximately R_{z}=7 μm to R_{z} less than 3 μm makes it possible to achieve a demonstrable increase in the torsional fatigue strength of the entire crankshaft 1 in the range of 10 to 30%. By way of rolling in the form of deep rolling (increasing the internal compressive stress), a significantly higher increase in strength is again to be expected. Firstly, there is thus the possibility of transmitting higher torsional moments by way of the crankshaft 1. Secondly, in the context of a lightweight construction approach with an identical torque to be transmitted, the crankshaft 1 can be constructed in a more lightweight manner and thus with less starting material.

### LIST OF REFERENCE DESIGNATIONS

1. Crankshaft
2. Main bearing
3. Crankpin
4. Crank web
5. First toothed ring
6. Crankshaft surface
7. Second toothed ring
8. Toothed ring flank
9. Flange

1.-7. (canceled)

8. A crankshaft for a reciprocating-piston internal combustion engine, comprising:
at least two main bearings;
at least a first toothed ring for a drive of a chain drive; and
a crankpin, wherein
a respective crank web is arranged between the main bearings and the crankpin,
the crank webs connect the main bearings to the crankpin,
the first toothed ring is axially spaced apart from a main bearing, and
a crankshaft surface between the main bearing and the first toothed ring has a mean roughness depth R_{z} of less than 3 μm.

9. The crankshaft according to claim 8, further comprising: a second toothed ring that is provided so as to be axially spaced apart from the first toothed ring, wherein
the crankshaft surface between the first toothed ring and the second toothed ring has a mean roughness depth R_{z} of less than 3 μm.

10. The crankshaft according to claim 9, wherein the crankshaft surface adjacent to the second toothed ring, on the side opposite the first toothed ring, has a mean roughness depth R_{z} of less than 3 μm.

11. The crankshaft according to claim 10, wherein the mean roughness depth R_{z} is produced by grinding or finishing or rolling.

12. The crankshaft according to claim 11, wherein the crankshaft is produced from a steel material.

13. The crankshaft according to claim 12, wherein the steel material is C38+N or C38mod or 44MnSiVS6 or 37CrS4mod or 42CrMo4.

14. The crankshaft according to claim 13, wherein the crankshaft surface with the mean roughness depth R_{z} of less than 3 μm extends up to toothed ring flanks.
